(19) United States
(12) Patent Application Publication
(10) Pub. No.: US 2020/0136100 A1
(43) Pub. Date: Apr. 30, 2020

(54) BATTERY

(71) Applicant: Envision AESC Energy Devices, Ltd., Sagamihara-shi (JP)

(72) Inventors: Yoshimasa YAMAMOTO, Sagamihara-shi (JP); Ryota YANAGISAWA, Sagamihara-shi (JP)

(73) Assignee: Envision AESC Energy Devices, Ltd., Sagamihara-shi (JP)

(21) Appl. No.: 16/661,496

(22) Filed: Oct. 23, 2019

(30) Foreign Application Priority Data
Oct. 24, 2018 (JP) 2018-200252

(51) Int. Cl. H01M 2/02; H01M 10/0583; H01M 4/485

(52) U.S. Cl. CPC H01M 2/029; H01M 2004/028; H01M 4/485; H01M 10/0583

(57) ABSTRACT

A separator includes a base material and insulating layers. The insulating layers are on both surfaces (first surface and second surface) of the base material. Each active material layer has a thickness equal to or less than 60 μm. A ratio of the thickness of the insulating layer (a total of the thickness of the insulating layer on the first surface of the base material and the thickness of the insulating layer on the second surface of the base material) to the thickness of the base material is equal to or greater than 1.50 and equal to or less than 3.00.

This application is based on Japanese patent application NO. 2018-200252, the content of which is incorporated hereinto by reference.

### BACKGROUND

### Technical Field

The invention relates to a battery.

### Related Art

Secondary batteries, particularly non-aqueous electrolyte secondary batteries are developed as one kind of the battery. The non-aqueous electrolyte secondary battery includes a positive electrode, a negative electrode, and a separator. The separator is positioned between the positive electrode and the negative electrode.

Japanese Unexamined Patent Publication No. 2009-231281 discloses an example of the separator. The separator includes a polyethylene microporous membrane and a heat-resistant porous layer on both surfaces of the polyethylene microporous membrane. The heat-resistant porous layer includes an inorganic filler formed of polymetaphenylene isophthalamide and aluminum hydroxide.

Japanese Unexamined Patent Publication No. 2010-160939 discloses another example of the separator. The separator includes a polyethylene microporous membrane and a porous layer on both surfaces of the polyethylene microporous membrane. The porous layer includes an inorganic filler formed of meta-type wholly aromatic polyamide and α-alumina.

Japanese Unexamined Patent Publications No. 2008-311221 and 2008-307893 disclose still another example of the separator. The separator includes a polyethylene porous film and a heat-resistant porous layer on the polyethylene porous film. The heat-resistant porous layer includes liquid crystal polyester and alumina particles.

Japanese Unexamined Patent Publication No. 2010-165664 discloses improvement of resistance of a battery in a crushing test. In the publication, a tensile elongation percentage of a positive electrode, a tensile elongation percentage of a negative electrode, and a tensile elongation percentage of a separator are specified, in order to improve the resistance in the crushing test.

### SUMMARY

The inventors have found it difficult to balance a high rate and high safety in the battery. Specifically, the inventors have found that resistance (that is, safety) of a battery in a nail penetration test can be deteriorated when a thickness of an active material layer of an electrode (for example, positive electrode or negative electrode) is decreased for the high rate.

An example of the object of the invention is to balance a high rate and high safety. Another object of the invention will be clearly shown from the disclosure of the specification.

In one embodiment, there is provided a battery comprising:
an electrode capable of functioning as a positive electrode or a negative electrode; and
a separator comprising a base material and an insulating layer,
wherein the electrode comprises a current collector comprising a first surface and a second surface opposite to the first surface, and an active material layer positioned over the first surface of the current collector and having a thickness equal to or less than 60 μm, and
a ratio of a thickness of the insulating layer to a thickness of the base material is equal to or greater than 1.50 and equal to or less than 3.00.

According to the one embodiment of the invention, it is possible to balance a high rate and high safety.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a top view of a battery according to an embodiment.

FIG. 2 is a A-A′ sectional view of FIG. 1.

FIG. 3 is an enlarged view of one part of FIG. 2.

### DETAILED DESCRIPTION

The invention will be now described herein with reference to illustrative embodiments. Those skilled in the art will recognize that many alternative embodiments can be accomplished using the teachings of the present invention and that the invention is not limited to the embodiments illustrated for explanatory purposes.

Hereinafter, an embodiment of the invention will be described with reference to the drawings. In all of the drawings, the similar reference numerals are used for the similar constituent elements and the description will not be repeated.

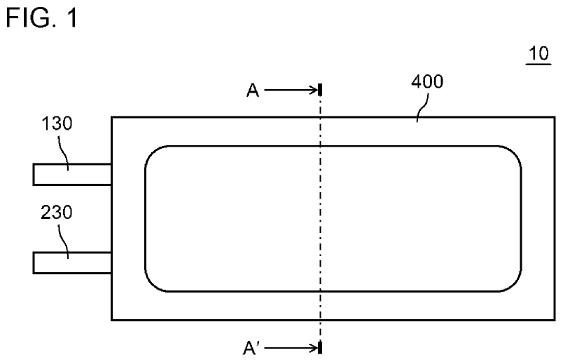

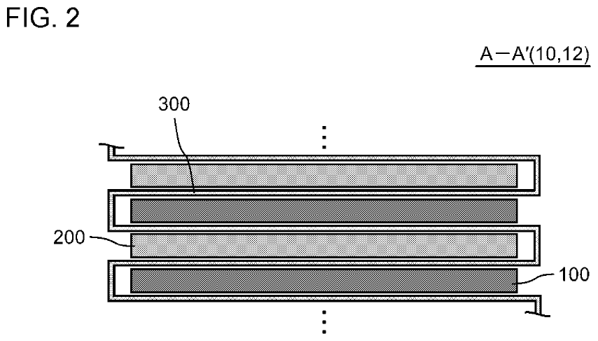

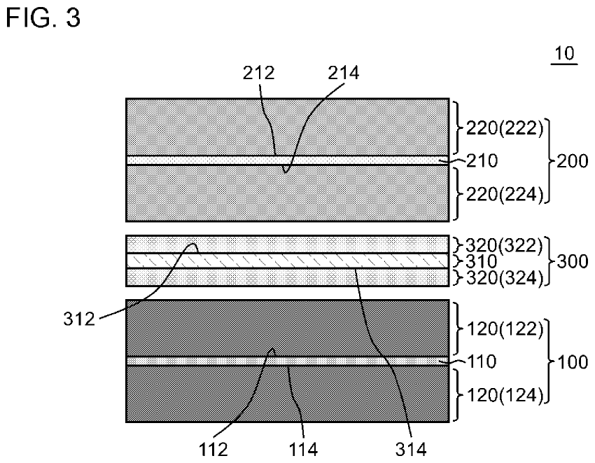

FIG. 1 is a top view of a battery 10 according to the embodiment. FIG. 2 is an A-A′ sectional view of FIG. 1. FIG. 3 is an enlarged view of one part of FIG. 2. FIG. 2 does not show an outer package 400 shown in FIG. 1, for the description.

The outline of the battery 10 will be described with reference to FIG. 3. The battery 10 includes a positive electrode 100, a negative electrode 200, and a separator 300. The separator 300 includes a base material 310 and insulating layers 320. In the example shown in FIG. 3, the insulating layers 320 are on both surfaces (first surface 312 and second surface 314) of the base material 310. The positive electrode 100 includes a current collector 110, an active material layer 122, and an active material layer 124. The current collector 110 includes a first surface 112 and a second surface 114. The second surface 114 is opposite to the first surface 112. The active material layer 122 and the active material layer 124 are respectively positioned on the first surface 112 and the second surface 114 of the current collector 110. The negative electrode 200 includes a current collector 210, an active material layer 222, and an active material layer 224. The current collector 210 includes a first surface 212 and a second surface 214. The second surface 214 is opposite to the first surface 212. The active material layer 222 and the active material layer 224 are respectively positioned on the first surface 212 and the second surface 214 of the current collector 210. Each of the active material layer 122, the active material layer 124, the active material layer 222, and the active material layer 224 has a thickness equal to or less than 60 μm. A ratio of a thickness of the insulating layer 320 (in the example shown in FIG. 3, a total of a thickness of the insulating layer 320 (insulating layer 322) on the first surface 312 of the base material 310 and a thickness of the insulating layer 320 (insulating layer 324) on the second surface 314 of the base material 310) to a thickness of the base material 310 is equal to or greater than 1.50 and equal to or less than 3.00.

According to the configuration described above, it is possible to balance a high rate and high safety. Specifically, in the configuration described above, each active material layer (the active material layer 122, the active material layer 124, the active material layer 222, or the active material layer 224) of each electrode (the positive electrode 100 or the negative electrode 200) is thin as described above, for realizing a high rate. Specifically, electric resistance between both surfaces of the active material layer is decreased with decreasing a distance between both surfaces of the active material layer (a surface at the current collector side and the opposite surface). Accordingly, a large current can flow between both surfaces of the active material layer under a constant voltage. The inventors have found that resistance (that is, safety) in a nail penetration test may be decreased due to low resistance between both surfaces of the active material layer when the thickness of the active material layer is small. The inventors have studied a structure for improving the resistance in the nail penetration test, and as a result, the inventors have focused on the ratio of the thickness of the insulating layer 320 to the thickness of the base material 310, and found that the resistance in the nail penetration test is improved when this ratio is in the range described above.

In the example shown in FIG. 3, the insulating layers 320 are on both surfaces (first surface 312 and second surface 314) of the base material 310. In another example, the insulating layer 320 may be on any one of both surfaces (first surface 312 and second surface 314) of the base material 310. Also in this example, a ratio of a thickness of the insulating layer 320 to a thickness of the base material 310 may be equal to or greater than 1.50 and equal to or less than 3.00.

The details of the battery 10 will be described with reference to FIG. 1.

The battery 10 includes a first lead 130, a second lead 230, and an outer package 400.

The first lead 130 is electrically connected to the positive electrode 100 shown in FIG. 2. The first lead 130 may be formed of, for example, aluminum or an aluminum alloy.

The second lead 230 is electrically connected to the negative electrode 200 shown in FIG. 2. The second lead 230 may be formed of, for example, copper, a copper alloy, nickel-plated copper, or a nickel-plated copper alloy.

In the example shown in FIG. 1, the outer package 400 has a rectangular shape having four sides. In the example shown in FIG. 1, the first lead 130 and the second lead 230 are protruded from one common side of the four sides of the outer package 400. In another example, the first lead 130 and the second lead 230 may be protruded from different sides (for example, opposite sides) of the four sides of the outer package 400.

The outer package 400 accommodates a laminate 12 shown in FIG. 2, together with an electrolyte (not shown).

The outer package 400 includes, for example, a thermally fusible resin layer and a barrier layer, and may be, for example, a laminate film including a thermally fusible resin layer and a barrier layer.

A resin material forming the thermally fusible resin layer may be, for example, polyethylene (PE), polypropylene, nylon, polyethylene terephthalate (PET), or the like. A thickness of the thermally fusible resin layer is, for example, equal to or greater than 20 μm and equal to or less than 200 μm, preferably equal to or greater than 30 μm and equal to or less than 150 μm, and more preferably equal to or greater than 50 μm and equal to or less than 100 μm.

The barrier layer has, for example, barrier properties such as preventing leakage of the electrolyte or penetration of moisture from the outside, and may be, for example, a barrier layer formed of metal such as stainless steel (SUS) foil, aluminum foil, aluminum alloy foil, copper foil, titanium foil, or the like. A thickness of the barrier layer is, for example, equal to or greater than 10 μm and equal to or less than 100 μm, preferably equal to or greater than 20 μm and equal to or less than 80 μm, and more preferably equal to or greater than 30 μm and equal to or less than 50 μm.

The thermally fusible resin layer of the laminate film may be one layer or two or more layers. In the same manner, the barrier layer of the laminate film may be one layer or two or more layers.

The electrolyte is, for example, a non-aqueous electrolyte. This non-aqueous electrolyte may include a lithium salt and a solvent for dissolving lithium salt.

Examples of the lithium salt may include LiClO₄, LiBF₄, LiPF₆, LiCF₃SO₃, LiCF₃CO₂, LiAsF₆, LiSbF₆, LiB₁₀Cl₁₀, LiAlCl₄, LiCl, LiBr, LiB(C₂H₅)₄, CF₃SO₃Li, CH₃SO₃Li, LiC₄F₉SO₃, Li(CF₃SO₂)₂N, and lower fatty acid lithium carboxylate.

Examples of the solvent for dissolving a lithium salt may include carbonates such as ethylene carbonate (EC), propylene carbonate (PC), butylene carbonate (BC), dimethyl carbonate (DMC), ethyl methyl carbonate (EMC), diethyl carbonate (DEC), methyl ethyl carbonate (MEC), and vinylene carbonate (VC); lactones such as γ-butyrolactone and γ-valerolactone; ethers such as trimethoxymethane, 1,2-dimethoxyethane, diethyl ether, tetrahydrofuran, and 2-methyltetrahydrofuran; sulfoxides such as dimethyl sulfoxide; oxolanes such as 1,3-dioxolane and 4-methyl-1,3-dioxolane; a nitrogen-containing solvent such as acetonitrile, nitromethane, formamide, and dimethylformamide; organic acid esters such as methyl formate, methyl acetate, ethyl acetate, butyl acetate, methyl propionate, and ethyl propionate; phosphate triesters and diglymes; triglymes; sulfolanes such as sulfolane and methyl sulfolane; oxazolidinones such as 3-methyl-2-oxazolidinone; and sultones such as 1,3-propane sultone, 1,4-butane sultone, and naphtha sultone. These substances may be used alone or in combination thereof.

The details of the laminate 12 will be described with reference to FIG. 2.

The laminate 12 includes the plurality of positive electrodes 100, the plurality of negative electrodes 200, and the separator 300. The plurality of positive electrodes 100 and the plurality of negative electrodes 200 are alternately laminated on each other. In the example shown in FIG. 2, the separator 300 is folded in zigzags such that a part of the separator 300 is positioned between the adjacent positive electrode 100 and negative electrode 200. In another example, a plurality of spaced-apart separators 300 may be positioned between the adjacent positive electrode 100 and negative electrode 200.

The details of each of the positive electrode 100, the negative electrode 200, and the separator 300 will be described with reference to FIG. 3.

The positive electrode 100 includes the current collector 110 and the active material layers 120 (the active material layer 122 and the active material layer 124). The current collector includes the first surface 112 and the second surface 114. The second surface 114 is on a side opposite to the first surface 112. The active material layer 122 is on the first surface 112 of the current collector 110. The active material layer 124 is on the second surface 114 of the current collector 110.

The current collector 110 may be formed of, for example, aluminum, stainless steel, nickel, titanium, or an alloy thereof. A shape of the current collector 110 may be, for example, a foil, a flat plate, or a mesh.

The active material layers 120 (the active material layer 122 and the active material layer 124) include an active material, a binder resin, and a conductive aid.

Examples of the active material included in the active material layers 120 (the active material layer 122 and the active material layer 124) include LiNiₐM₁₋ₐO₂ (M is at least one or more kinds of element selected from Co, Mn, Al, Na, Ba, and Mg) (for example, lithium-nickel composite oxide, lithium-nickel-cobalt composite oxide, lithium-nickel-manganese composite oxide, lithium-nickel-aluminum composite oxide, lithium-nickel-sodium composite oxide, lithium-nickel-barium composite oxide, lithium-nickel-magnesium composite oxide, lithium-nickel-cobalt-manganese composite oxide, lithium-nickel-cobalt-aluminum composite oxide, lithium-nickel-cobalt-sodium composite oxide, lithium-nickel-cobalt-barium composite oxide, lithium-nickel-cobalt-magnesium composite oxide, lithium-nickel-manganese-aluminum composite oxide, lithium-nickel-manganese-sodium composite oxide, lithium-nickel-manganese-barium composite oxide, lithium-nickel-manganese-magnesium composite oxide, lithium-nickel-aluminum-sodium composite oxide, lithium-nickel-aluminum-barium composite oxide, lithium-nickel-aluminum-magnesium composite oxide, lithium-nickel-sodium-barium composite oxide, lithium-nickel-sodium-magnesium composite oxide, lithium-nickel-barium-magnesium composite oxide, lithium-nickel-cobalt-manganese-aluminum composite oxide, lithium-nickel-cobalt-manganese-sodium composite oxide, lithium-nickel-cobalt-manganese-barium composite oxide, lithium-nickel-cobalt-manganese-magnesium composite oxide, lithium-nickel-cobalt-aluminum-sodium composite oxide, lithium-nickel-cobalt-aluminum-barium composite oxide, lithium-nickel-cobalt-aluminum-magnesium composite oxide, lithium-nickel-cobalt-sodium-barium composite oxide, lithium-nickel-cobalt-sodium-magnesium composite oxide, lithium-nickel-cobalt-barium-sodium composite oxide, lithium-nickel-manganese-aluminum-sodium composite oxide, lithium-nickel-manganese-aluminum-barium composite oxide, lithium-nickel-manganese-aluminum-magnesium composite oxide, lithium-nickel-manganese-sodium-barium composite oxide, lithium-nickel-manganese-sodium-magnesium composite oxide, lithium-nickel-manganese-barium-magnesium composite oxide, lithium-nickel-aluminum-sodium-barium composite oxide, lithium-nickel-aluminum-sodium-magnesium composite oxide, lithium-nickel-sodium-barium-magnesium composite oxide, lithium-nickel-cobalt-manganese-aluminum-sodium composite oxide, lithium-nickel-cobalt-manganese-aluminum-barium composite oxide, lithium-nickel-cobalt-manganese-aluminum-magnesium composite oxide, lithium-nickel-cobalt-manganese-sodium-barium composite oxide, lithium-nickel-cobalt-manganese-sodium-magnesium composite oxide, lithium-nickel-cobalt-manganese-barium-magnesium composite oxide, lithium-nickel-cobalt-aluminum-sodium-barium composite oxide, lithium-nickel-cobalt-aluminum-sodium-magnesium composite oxide, lithium-nickel-cobalt-sodium-barium-magnesium composite oxide, lithium-nickel-manganese-aluminum-sodium-barium composite oxide, lithium-nickel-manganese-aluminum-sodium-magnesium composite oxide, lithium-nickel-manganese-sodium-barium-magnesium composite oxide, lithium-nickel-aluminum-sodium-barium-magnesium composite oxide, lithium-nickel-cobalt-manganese-aluminum-sodium-barium composite oxide, lithium-nickel-cobalt-manganese-aluminum-sodium-magnesium composite oxide, lithium-nickel-manganese-aluminum-sodium-barium-magnesium composite oxide, and lithium-nickel-cobalt-manganese-aluminum-sodium-barium-magnesium composite oxide). A composition ratio a of LiNiₐM₁₋ₐO₂ may be suitably determined in accordance with, for example, an energy density of the battery 10. The energy density of the battery 10 increases with increasing the composition ratio a. The composition ratio a is, for example, a≥0.50 and preferably a≥0.80. In another example, the active material included in the active material layers 120 (the active material layer 122 and the active material layer 124) may be composite oxide of lithium and transition metal such as lithium-cobalt composite oxide or lithium-manganese composite oxide; a transition metal sulfide such as TiS₂, FeS, or MoS₂; transition metal oxide such as MnO, V₂O₅, V₆O₁₃, or TiO₂; or olivine type lithium phosphorus oxide. The olivine type lithium phosphorus oxide includes, for example, at least one kind of element of the group consisting of Mn, Cr, Co, Cu, Ni, V, Mo, Ti, Zn, Al, Ga, Mg, B, Nb, and Fe, lithium, phosphorus, and oxygen. In these compounds, some elements may be partially substituted with other elements, in order to improve properties thereof. These substances may be used alone or in combination thereof.

A density of the active material included in the active material layers 120 (the active material layer 122 and the active material layer 124) is, for example, equal to or greater than 2.0 g/cm³ and equal to or less than 4.0 g/cm³, preferably 2.4 g/cm³ and equal to or less than 3.8 g/cm³, more preferably equal to or greater than 2.8 g/cm³ and equal to or less than 3.6 g/cm³.

A thickness of the active material layer (the active material layer 122 or the active material layer 124) on one surface of both surfaces (the first surface 112 and the second surface 114) of the current collector 110 may be suitably determined in accordance with, for example, a rate of the battery 10. The rate of the battery 10 increases with decreasing the thickness. The thickness is, for example, equal to or less than 60 μm, preferably equal to or less than 50 μm, and more preferably equal to or less than 40 μm.

A total thickness of the active material layers (the active material layer 122 and the active material layer 124) on both surfaces (the first surface 112 and the second surface 114) of the current collector 110 may be suitably determined in accordance with, for example, a rate of the battery 10. The rate of the battery 10 increases with decreasing the thickness. The thickness is, for example, equal to or less than 120 μm, preferably equal to or less than 100 μm, and more preferably equal to or less than 80 μm.

The active material layers 120 (the active material layer 122 and the active material layer 124) can be manufactured, for example, as follows. First, an active material, a binder resin, and a conductive aid are dispersed in an organic solvent to prepare a slurry. The organic solvent is, for example, N-methyl-2-pyrrolidone (NMP). Next, this slurry is applied on the first surface 112 of the current collector 110, the slurry is dried, the pressing is performed as necessary, and the active material layer 120 (active material layer 122) is formed on the current collector 110. The active material layer 124 can also be formed in the same manner.

A binder resin included in the active material layers 120 (the active material layer 122 and the active material layer 124) is, for example, polytetrafluoroethylene (PTFE) or polyvinylidene fluoride (PVDF).

The amount of the binder resin included in the active material layer 120 (the active material layer 122 or the active material layer 124) may be suitably determined. The amount of binder resin included in the active material layer 122 is, for example, equal to or greater than 0.1 parts by mass and equal to or less than 10.0 parts by mass, preferably equal to or greater than 0.5 parts by mass and equal to or less than 5.0 parts by mass, and more preferably equal to or greater than 2.0 parts by mass and equal to or less than 4.0 parts by mass, based on 100 parts by mass of a total mass of the active material layer 122. The same applies to the active material layer 124.

The conductive aid included in the active material layers 120 (the active material layer 122 and the active material layer 124) is, for example, carbon black, Ketjen black, acetylene black, natural graphite, artificial graphite, carbon fiber, or the like. Graphite may be, for example, flake graphite or spherical graphite. These materials may be used alone or in combination thereof.

The amount of conductive aid included in the active material layer 120 (the active material layer 122 or the active material layer 124) may be suitably determined in accordance with, for example, cycling properties of the battery 10. The cycling properties of the battery 10 are improved with increasing the amount of conductive aid of the active material layer 120. The amount of conductive aid included in the active material layer 120 is, for example, equal to or greater than 3.0 parts by mass and equal to or less than 8.0 parts by mass and preferably equal to or greater than 5.0 parts by mass and equal to or less than 6.0 parts by mass, based on 100 parts by mass of a total mass of the active material layer 122. The same applies to the active material layer 124.

The negative electrode 200 includes the current collector 210 and active material layer 220 (the active material layer 222 and the active material layer 224). The current collector 210 includes the first surface 212 and the second surface 214. The second surface 214 is opposite to the first surface 212. The active material layer 222 is on the first surface 212 of the current collector 210. The active material layer 224 is on the second surface 214 of the current collector 210.

The current collector 210 may be formed of, for example, copper, stainless steel, nickel, titanium, or an alloy thereof. A shape of the current collector 210 may be, for example, a foil, a flat plate, or a mesh.

The active material layers 220 (the active material layer 222 and the active material layer 224) include an active material and a binder resin. The active material layers 220 may further include a conductive aid, if necessary.

Examples of the active material included in the active material layers 220 (the active material layer 222 and the active material layer 224) include a carbon material such as graphite storing lithium, amorphous carbon, diamond-like carbon, fullerene, carbon nanotube, or carbon nanohorn; a lithium-based metal material such as lithium metal or lithium alloy, an Si-based material such as Si, SiO₂, SiOₓ (0<x≤2), an Si-containing composite material; a conductive polymer material such as polyacene, polyacetylene, or polypyrrole. These materials may be used alone or in combination thereof. In one example, the active material layers 220 (the active material layer 222 and the active material layer 224) may include a first group of graphite particles (for example, natural graphite) having a first average particle diameter and a second group of graphite particles (for example, natural graphite) having a second average particle diameter. The second average particle diameter may be less than the first average particle diameter, a total mass of the second group of graphite particles may be less than a total mass of the first group of graphite particles, and the total mass of the second group of graphite particles may be, for example, equal to or greater than 20 parts by mass and equal to or less than 30 parts by mass based on 100 parts by mass of the total mass of the first group of graphite particles.

A density of the active material included in the active material layers 220 (the active material layer 222 and the active material layer 224) is, for example, equal to or greater than 1.2 g/cm³ and equal to or less than 2.0 g/cm³, preferably equal to or greater than 1.3 g/cm³ and equal to or less than 1.9 g/cm³, more preferably equal to or greater than 1.4 g/cm³ and equal to or less than 1.8 g/cm³.

A thickness of the active material layer (the active material layer 222 or the active material layer 224) on one surface of both surfaces (the first surface 212 and the second surface 214) of the current collector 210 may be suitably determined in accordance with, for example, a rate of the battery 10. The rate of the battery 10 increases with decreasing the thickness. The thickness is, for example, equal to or less than 60 μm, preferably equal to or less than 55 μm, and more preferably equal to or less than 50 μm.

A total thickness of the active material layers (the active material layer 222 and the active material layer 224) on both surfaces (the first surface 212 and the second surface 214) of the current collector 210 may be suitably determined in accordance with, for example, a rate of the battery 10. The rate of the battery 10 increases with decreasing the thickness. The thickness is, for example, equal to or less than 120 μm, preferably equal to or less than 110 μm, and more preferably equal to or less than 100 μm.

The active material layers 220 (the active material layer 222 and the active material layer 224) can be manufactured, for example, as follows. First, an active material and a binder resin are dispersed in a solvent to prepare a slurry. The organic solvent may be, for example, an organic solvent such as N-methyl-2-pyrrolidone (NMP) or water. Next, this slurry is applied on the first surface 212 of the current collector 210, the slurry is dried, the pressing is performed as necessary, and the active material layer 220 (active material layer 222) is formed on the current collector 210. The active material layer 224 can also be formed in the same manner.

A binder resin included in the active material layers 220 (the active material layer 222 and the active material layer 224) may be, for example, a binder resin such as polyvinylidene fluoride (PVDF) if the organic solvent is used as the solvent for obtaining a slurry, and may be, for example, a rubber-based binder (for example, styrene⋅butadiene rubber (SBR)) or an acryl-based binder resin if the water is used as the solvent for obtaining a slurry. Such a water-based binder resin may be an emulsion form. If the water is used as the solvent, the water-based binder and a thickener such as carboxymethyl cellulose (CMC) may be used in combination.

The amount of the binder resin included in the active material layer 220 (the active material layer 222 or the active material layer 224) may be suitably determined. The amount of binder resin included in the active material layer 222 is, for example, equal to or greater than 0.1 parts by mass and equal to or less than 10.0 parts by mass, preferably equal to or greater than 0.5 parts by mass and equal to or less than 8.0 parts by mass, more preferably equal to or greater than 1.0 part by mass and equal to or less than 5.0 parts by mass, and even more preferably equal to or greater than 1.0 part by mass and equal to or less than 3.0 parts by mass, based on 100 parts by mass of a total mass of the active material layer 222. The same applies to the active material layer 224.

The separator 300 includes the base material 310 and the insulating layers 320 (the insulating layer 322 and the insulating layer 324). The base material 310 includes the first surface 312 and the second surface 314. The second surface 314 is opposite to the first surface 312. The insulating layer 322 is on the first surface 312 of the base material 310. The insulating layer 324 is on the second surface 314 of the base material 310.

In the example shown in FIG. 3, the separator 300 includes the insulating layers 320 (the insulating layer 322 and the insulating layer 324) on both surfaces (the first surface 312 and the second surface 314) of the base material 310. In another example, the separator 300 may include the insulating layer 320 only on one surface of both surfaces (the first surface 312 and the second surface 314) of the base material 310.

The separator 300 has a function of electrically insulating the positive electrode 100 and the negative electrode 200 from each other, and transmitting ions (for example, lithium ions). The separator 300 may be, for example, a porous separator.

The shape of the separator 300 may be suitably determined in accordance with the shape of the positive electrode 100 or the negative electrode 200, and may be, for example, a rectangular shape.

The base material 310 preferably includes a resin layer including a heat-resistant resin. The resin layer includes the heat-resistant resin as a main component, and specifically, the amount of the heat-resistant resin is equal to or greater than 50 parts by mass, preferably equal to or greater than 70 parts by mass, and more preferably equal to or greater than 90 parts by mass, based on 100 parts by mass of a total mass of the resin layer, and the amount of the heat-resistant resin may be 100 parts by mass based on 100 parts by mass of the total mass of the resin layer. The resin layer may be a single layer or may be a layer of two or more kinds of layers.

The heat-resistant resin is, for example, one kind or two or more kinds selected from polyethylene, polyethylene terephthalate, polybutylene terephthalate, polyethylene naphthalate, poly-m-phenylene terephthalate, poly-p-phenylene isophthalate, polycarbonate, polyester carbonate, aliphatic polyamide, wholly aromatic polyamide, semi-aromatic polyamide, wholly aromatic polyester, polyphenylene sulfide, polyparaphenylene benzobisoxazole, polyimide, polyarylate, polyetherimide, polyamideimide, polyacetal, polyetheretherketone, polysulfone, polyethersulfone, fluorine-based resin, polyethernitrile, modified polyphenylene ether, and the like.

The insulating layers 320 (the insulating layer 322 and the insulating layer 324) can be manufactured, for example, as follows. First, an inorganic filler and a resin are dispersed in a solvent to prepare a solution. Examples of the solvent include water, alcohols such as ethanol, N-methylpyrrolidone (NMP), toluene, dimethyl carbonate (DMC), ethyl methyl carbonate (EMC), and the like. Next, the solution is applied onto the first surface 312 of the base material 310 to form the insulating layer 320 (insulating layer 322). The insulating layer 324 can also be formed in the same manner.

A material for forming the inorganic filler included in the insulating layers 320 (the insulating layer 322 and the insulating layer 324) is, for example, one kind or two or more kinds selected from magnesium hydroxide, aluminum oxide, boehmite, titanium oxide, silicon oxide, magnesium oxide, barium oxide, zirconium oxide, zinc oxide, iron oxide, and the like. For example, the material is preferably magnesium hydroxide, from a viewpoint of improving the resistance in the nail penetration test.

Examples of the resin included in the insulating layers 320 (the insulating layer 322 and the insulating layer 324) include aramid (aromatic polyamide)-based resin such as meta-aramid or para-aramid; a cellulose-based resin such as carboxymethyl cellulose (CMC); an acryl-based resin; and a fluorine-based resin such as polyvinylidene fluoride (PVDF). Among these, aramid (aromatic polyamide)-based resin is preferable, and meta-aramid is more preferable. These substances may be used alone or in combination thereof.

A thickness of the base material 310 may be suitably determined, and may be, for example, equal to or greater than 5.0 μm and equal to or less than 10.0 μm, and preferably equal to or greater than 6.0 μm and equal to or less than 10.0 μm.

A total of the thickness of the insulating layer 322 and the thickness of the insulating layer 324 may be suitably determined, and may be, for example, equal to or greater than 10.0 μm and equal to or less than 20.0 μm and preferably equal to or greater than 12.5 μm and equal to or less than 17.5 μm.

A thickness of the separator 300 may be suitably determined, and may be, for example, equal to or greater than 15.0 μm and equal to or less than 30.0 μm and preferably equal to or greater than 16.0 μm and equal to or less than 27.5 μm.

In the example shown in FIG. 3, the positive electrode 100, the negative electrode 200, and the separator 300 are overlapped on each other such that the first surface 112 of the positive electrode 100 faces the second surface 314 of the separator 300 and the second surface 214 of the negative electrode 200 faces the first surface 312 of the separator 300.

### EXAMPLE

### Example 1

The battery 10 was manufactured as follows.

The positive electrode 100 was formed as follows. First, the following materials were dispersed in an organic solvent to prepare a slurry.

Active material: 94.0 parts by mass of lithium nickel-containing composite oxide (chemical formula (Li(Ni_{0.80}Co_{0.15}Al_{0.05})O₂))

Conductive aid: 2.0 parts by mass of spherical graphite and 1.0 part by mass of flake graphite

Binder resin: 3.0 parts by mass of polyvinylidene fluoride (PVDF)

Next, this slurry was applied on both surfaces (the first surface 112 and the second surface 114) of an aluminum foil (current collector 110) having a thickness of 15 μm, the slurry was dried, the pressing was performed, and the active material layers 120 (the active material layer 122 and the active material layer 124) were formed. A density of the active material of the active material layer 122 was 3.35 g/cm³, and a thickness of the active material layer 122 was 36.6 μm. A density of the active material of the active material layer 124 was 3.35 g/cm³, and a thickness of the active material layer 124 was 36.6 μm.

The negative electrode 200 was formed as follows. First, the following materials were dispersed in water to prepare a slurry.

Active material: 77.36 parts by mass of natural graphite (average particle diameter: 16.0 μm) and 19.34 parts by mass of natural graphite (average particle diameter: 10.5 μm)

Conductive aid: 0.3 parts by mass of spherical graphite.

Binder resin: 2.0 parts by mass of styrene⋅butadiene rubber (SBR)

Thickener: 1.0 part by mass of carboxymethyl cellulose (CMC)

Next, this slurry was applied on both surfaces (the first surface 212 and the second surface 214) of a copper foil (current collector 210) having a thickness of 8 μm, the slurry was dried, the pressing was performed, and the active material layers 220 (the active material layer 222 and the active material layer 224) were formed. A density of the active material of the active material layer 222 was 1.55 g/cm³, and a thickness of the active material layer 222 was 50.0 μm. A density of the active material of the active material layer 224 was 1.55 g/cm³, and a thickness of the active material layer 224 was 50.0 μm.

The separator 300 was formed as follows. First, the following materials were dispersed in a solvent to prepare a solution.

Inorganic filler: magnesium hydroxide

Resin: meta-aramid

Next, this solution was applied on both surfaces (the first surface 312 and the second surface 314) of a polyethylene film (base material 310) having a thickness of 6.0 μm, and the insulating layers 320 (the insulating layer 322 and the insulating layer 324) were formed. A total of the thickness of the insulating layer 322 (8.0 μm) and the thickness of the insulating layer 324 (8.0 μm) was 16.0 μm.

As shown in FIG. 2, the laminate 12 was formed such that fourteen positive electrodes 100 and fourteen negative electrodes 200 were alternately arranged and the separator 300 was folded in zigzags.

As shown in FIG. 1, the battery 10 was manufactured by accommodating the laminate 12 as well as electrolyte in outer package 400. The electrolyte includes LiPF₆.

The nail penetration test was performed on the battery 10. Specifically, a nail (SUS 304) having a diameter of 3 mm was stuck to the center of the battery 10 at 80 mm/s at room temperature with the State Of Charge (SOC) of the battery 10 being in a full charge. The nail penetration test of the battery was evaluated based on the following standard.

A: The ignition was not observed at a time-point of three minutes post start of the test.

B: The ignition was not observed in less than three minutes post start of the test (the ignition was observed at a time-point of three minutes post start of the test).

C: The ignition was observed in less than ten seconds post start of the test.

### Example 2

Example 2 was the same as Example 1, except that the thickness of the base material 310 was 9.0 μm and a total of the thickness of the insulating layer 322 (8.0 μm) and the thickness of the insulating layer 324 (8.0 μm) was 16.0 μm.

### Comparative Example 1

Comparative Example 1 was the same as Example 1, except that the thickness of the base material 310 was 7.5 μm and a total of the thickness of the insulating layer 322 (3.75 μm) and the thickness of the insulating layer 324 (3.75 μm) was 7.5 μm.

### Comparative Example 2

Comparative Example 2 was the same as Example 1, except that the thickness of the base material 310 was 9.0 μm and a total of the thickness of the insulating layer 322 (6.0 μm) and the thickness of the insulating layer 324 (6.0 μm) was 12.0 μm.

Table 1 shows respective results of Example 1, Example 2, Comparative Example 1, and Comparative Example 2.

| | | Thickness of | Nail |
|---|---|---|---|
| | Thickness of base | insulating | penetration |
| | material [μm] | layer [μm] | test |
| Example 1 | 6.0 | 16.0 | A |
| Example 2 | 9.0 | 16.0 | B |
| Comparative | 7.5 | 7.5 | C |
| Example 1 | | | |
| Comparative | 9.0 | 12.0 | C |
| Example 2 | | | |

The results shown in Table 1 suggest that the resistance in the nail penetration test can be improved in accordance with the ratio of the thickness of the insulating layer 320 to the thickness of the bas material 310. Specifically, the resistance in the nail penetration test can be improved with increasing the ratio of the thickness of the insulating layer 320 to the thickness of the base material 310. From the result of Example 2 (ratio of the thickness of the insulating layer 320 to the thickness of the base material 310: approximately 1.78), the ratio of thickness of the insulating layer 320 to the thickness of the base material 310 may be equal to or greater than 1.50. From the result of Example 1 (ratio of the thickness of the insulating layer 320 to the thickness of the base material 310: approximately 2.67), the ratio of thickness of the insulating layer 320 to the thickness of the base material 310 may be equal to or less than 3.00.

The reason why the resistance in the nail penetration test can be improved in accordance with the ratio of the thickness of the insulating layer 320 to the thickness of the base material 310 is assumed as follows. In the nail penetration test, heat can be generated from the nail due to short circuit of the positive electrode 100 and the negative electrode 200 through the nail. In the periphery of the region where the nail is penetrated and stuck, the base material 310 can shrink to leave from the nail due to heat generated from the nail, whereas the insulating layer 320 can prevent the shrinkage of the base material 310. If the insulating layer 320 cannot sufficiently prevent the shrinkage of the base material 310 and the base material 310 (that is, entirety of the separator 300) shrinks, the positive electrode 100 and the negative electrode 200 may come into contact with each other to cause the ignition in the periphery of the nail. In contrast, as described above, when the ratio of the thickness of the insulating layer 320 to the thickness of the base material 310 is great (that is, when the thickness of the base material 310 is small and the thickness of the insulating layer 320 is great), it is possible to prevent the shrinkage of the base material 310 by the insulating layer 320 and to improve the resistance in the nail penetration test.

Hereinabove, the embodiments and the examples of the invention have been described with reference to the drawings, but these are merely examples of the invention, and various other configurations can also be used.

It is apparent that the present invention is not limited to the above embodiment, and may be modified and changed without departing from the scope and spirit of the invention.

What is claimed is:

1. A battery comprising:
an electrode capable of functioning as a positive electrode or a negative electrode; and
a separator comprising a base material and an insulating layer,
wherein the electrode comprises a current collector comprising a first surface and a second surface opposite to the first surface, and an active material layer positioned over the first surface of the current collector and having a thickness equal to or less than 60 μm, and
a ratio of a thickness of the insulating layer to a thickness of the base material is equal to or greater than 1.50 and equal to or less than 3.00.

2. The battery according to claim 1,
wherein the insulating layer comprises magnesium hydroxide.

3. The battery according to claim 1,
wherein the insulating layer further comprises aromatic polyamide.

4. The battery according to claim 1,
wherein the positive electrode comprises an active material layer, and
wherein the active material layer of the positive electrode comprises equal to or greater than 5.0 parts by mass of a conductive aid based on 100 parts by mass of a total mass of the active material layer of the positive electrode.

5. The battery according to claim 1,
wherein the separator is folded in zigzags such that a part of the separator is positioned between the adjacent positive electrode and negative electrode.
